(19) United States
(12) Patent Application Publication
(10) Pub. No.: US 2015/0080045 A1
(43) Pub. Date: Mar. 19, 2015

(54) BASE STATION, WIRELESS COMMUNICATION SYSTEM, AND WIRELESS COMMUNICATION METHOD

(71) Applicant: FUJITSU LIMITED, Kawasaki-shi (JP)

(72) Inventor: Seiji HAMADA, Kawasaki (JP)

(21) Appl. No.: 14/486,462

(22) Filed: Sep. 15, 2014

(30) Foreign Application Priority Data
Sep. 17, 2013 (JP) 2013-192284

(51) Int. Cl. H04W 74/08

(52) U.S. Cl. CPC H04W 74/085
USPC 455/515

(57) ABSTRACT

A base station including: a receiver configured to receive a random access signal wirelessly transmitted from a terminal, a transmitter configured to wirelessly transmit a response signal in response to the random access signal, and a processer configured to limit a transmission of the response signal based on a timing difference between a reference timing and a reception timing when the random access signal has been received.

### CROSS-REFERENCE TO RELATED APPLICATION

This application is based upon and claims the benefit of priority of the prior Japanese Patent Application No. 2013-192284, filed on Sep. 17, 2013, the entire contents of which are incorporated herein by reference.

### FIELD

The embodiments discussed herein are related to a base station, a wireless communication system and a wireless communication method.

### BACKGROUND

To date, wireless communication systems of long term evolution (LTE) and so forth are known. There is also known random access processing with which, in a wireless communication system, the occurrence of collisions of signals is reduced when a plurality of mobile stations make requests for communication at the same time, so that communication channels are set with good efficiency (for example, refer to International Publication Pamphlet No. WO 2010/050497 and Japanese National Publication of International Patent Application No. 2012-526425). In the random access processing, random access channels (RACHs) are used in order for a mobile station to make a request for allocation of communication channels.

### SUMMARY

According to an aspect of the invention, a base station includes a receiver configured to receive a random access signal wirelessly transmitted from a terminal, a transmitter configured to wirelessly transmit a response signal in response to the random access signal, and a processer configured to limit a transmission of the response signal based on a timing difference between a reference timing and a reception timing when the random access signal has been received.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a block diagram illustrating an example of a communication system according to a first embodiment;

FIG. 1B is a block diagram illustrating an example of the flow of signals in the communication system illustrated in FIG. 1A.

FIG. 2 is a block diagram illustrating an example of a communication system according to a second embodiment;

FIG. 3 is a sequence diagram illustrating an example of initial access of a mobile station to a wireless base station device;

FIG. 4A is a block diagram illustrating an example of a base station device according to the second embodiment;

FIG. 4B is a block diagram illustrating an example of the flow of signals in the base station device illustrated in FIG. 4A;

FIG. 5A is a block diagram illustrating an example of a random access signal processing unit;

FIG. 5B is a block diagram illustrating an example of the flow of signals in the random access signal processing unit illustrated in FIG. 5A;

FIG. 6 is a sequence diagram illustrating an example of random access signal detection processing;

FIG. 7 is a graph illustrating an example of a delay profile;

FIG. 8 is a graph illustrating a first example of limitation of response processing based on a result of detection;

FIG. 9 is a flowchart illustrating an example of processing performed by a base station device according to the first example;

FIG. 10A is a table illustrating an example of results of detection for every random access signal ID;

FIG. 10B is a table illustrating an example of the number of detections for every TA command value;

FIG. 10C is a table illustrating an example of a result of comparison between the number of detections for every TA command value and a threshold;

FIG. 10D is a table illustrating an example of a result of discarding of random access signals for every TA command value;

FIG. 11 is a graph illustrating a second example of limitation of response processing based on a result of detection;

FIG. 12 is a flowchart illustrating an example of processing performed by the base station device according to the second example;

FIG. 13A is a table illustrating an example of a comparison result between the number of detections for every TA command value and a threshold;

FIG. 13B is a table illustrating an example of a result of discard of random access signals for every TA command value;

FIG. 14A is a block diagram illustrating an example of a mobile station according to the second embodiment;

FIG. 14B is a block diagram illustrating an example of the flow of signals in the mobile station illustrated in FIG. 14A; and

FIG. 15 is a pictorial representation illustrating an example of application of a communication system according to the second embodiment.

### DESCRIPTION OF EMBODIMENTS

Hereinafter, embodiments of a base station and a wireless communication system according to the present disclosure will be described in detail with reference to the accompanying drawings.

In the aforementioned conventional technology, even if random access processing has been performed, there are some cases where a mobile station moves past and away from a base station device in a short period of time and therefore the random access processing becomes unnecessary, which raises the problem that the throughput of the base station device decreases.

In one aspect, it is an object of the disclosed embodiments to provide a base station device and a communication system with which throughput may be improved.

### First Embodiment

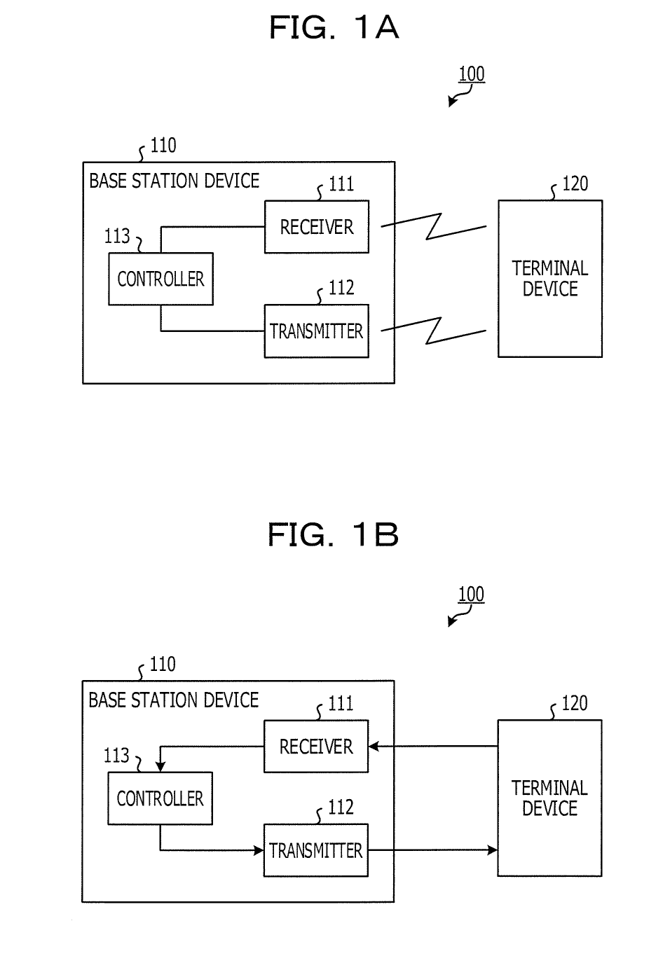

FIG. 1A is a block diagram illustrating an example of a communication system according to a first embodiment. FIG. 1B is a block diagram illustrating an example of the flow of signals in the communication system illustrated in FIG. 1A. As illustrated in FIG. 1A and FIG. 1B, a communication system 100 according to the first embodiment includes a base station device 110 and a terminal device 120.

The terminal device 120 is a communication device, such as a mobile station, which is capable of wirelessly communicating with the base station device 110. The terminal device 120 may be implemented as a plurality of terminal devices. At the time of establishing wireless communication with the base band device 110, the terminal device 120 wirelessly transmits, for example, a contention-based random access signal (RACH preamble) to the base station device 110.

The base station device 110 performs wireless communication with a terminal device (for example, the terminal device 120) located in the cell of the base station device 110. The base station device 110 includes a receiver 111, a transmitter 112, and a controller 113. The receiver 111 receives a random access signal wirelessly transmitted from the terminal device 120. Then, the receiver 111 outputs a result of reception of the random access signal to the controller 113.

In accordance with control from the controller 113, the transmitter 112 wirelessly transmits a response signal in response to the random access signal received by the receiver 111. As a result, the transmitter 112 is capable of performing random access processing with the terminal device 120.

The controller 113 controls wireless transmission of response signals performed by the transmitter 112. For example, the controller 113 derives information indicating a timing difference relative to a reference point in time (reference timing) of a random access signal received by the receiver 111, based on a result of reception (reception timing) of the random access signal output from the receiver 111. Then, based on the derived information indicating a timing difference, the controller 113 controls limitation (or suppression) of wireless transmission of a response signal performed by the transmitter 112.

In this way, with the base station device 110, limitation of wireless transmission of a response signal may be controlled in accordance with a timing difference relative to the reference point in time of the received random access signal. This may reduce unnecessary random access processing, thereby improving throughput.

### Specific Example of Information Indicating Timing Difference

For example, the controller 113 measures a timing difference relative to the reference point in time of a random access signal received by the receiver 111. Then, the controller 113 causes a response signal containing a timing adjustment (TA), which gives an instruction for adjusting the timing of transmission of a wireless signal by the measured timing difference, to be wirelessly transmitted from the transmitter 112.

Thereby, the terminal device 120 is capable of adjusting the timing of transmission of a wireless signal performed by the terminal device 120. In this case, information indicating a timing difference relative to the reference point in time of a random access signal may be referred to as, for example, a TA command. However, the information indicating a timing difference relative to the reference point in time of a random access signal is not limited to the TA command and may be, for example, a value obtained by digitizing the measured timing difference by a predetermined resolution. The timing difference indicated by the TA command is referred to as a TA command value hereinafter.

### Specific Example of Limitation of Wireless Transmission of Response Signal

For example, the controller 113 measures timing differences relative to the reference point in time of a plurality of random access signals received by the receiver 111 within a predetermined period of time. The controller 113 also classifies the plurality of random access signals into groups each in accordance with a measured timing difference. Then, the controller 113 extracts, among the groups, a group where the number of random access signals classified into that group exceeds a predetermined number.

If a group where the number of random access signals classified into that group exceeds the predetermined number is extracted, the controller 113 also limits (in other words, suppresses, ceases, discontinues, prevents or prohibits) wireless transmission of a response signal performed by the transmitter 112 in response to a random access signal classified into the extracted group. For example, the controller 113 controls the transmitter 112 so as not to wirelessly transmit response signals in response to at least some of the random access signals classified into the extracted group.

Here, all the random access signals classified into the same group may be estimated to be random access signals transmitted from terminal devices whose distances from the base station device 110 are at the same level. Therefore, each random access signal of a group containing a large number of random access signals is highly likely to be a random access signal transmitted from one of terminal devices that are located close together. In many cases, such terminal devices are, for example, terminal devices that are moving due to being on a (public) transportation vehicle, such as a train.

Accordingly, by limiting wireless transmission of response signals in response to random access signals transmitted from such terminal devices, it is possible to reduce random access processing of the terminal devices that are highly likely to move out of range of the base station device 110, or to be handed over, in a short period of time. The throughput in the base station device 110 may therefore be improved.

### Exclusion from Limitation for Timing Difference

The base station device 110 may also include a storage unit configured to store information indicating a predetermined timing difference. The predetermined timing difference is, for example, a timing difference relative to the reference point in time in the base station device 110, which is calculated in the base station device 110 for a random access signal transmitted from a predetermined location through which a transportation vehicle, such as a train, passes.

The location through which a transportation vehicle, such as a train, passes is limited, and therefore the timing difference measured for a random access signal transmitted from a predetermined location through which a transportation vehicle, such as a train, passes is also limited. Therefore, based on an actual measurement value and so on, information indicating a predetermined timing difference may be stored in advance.

The information indicating a predetermined timing difference is not limited to information indicating the predetermined timing itself, and may be information by which the predetermined timing difference is identifiable. For example, the information indicating a predetermined timing difference may be information indicating each timing difference different from the predetermined timing difference.

The controller 113 may be configured not to limit wireless transmission of a response signal performed by the transmitter 112 for a random access signal having a timing difference different from the predetermined timing difference, based on information stored by the storage unit. Thus, wireless transmission of a response signal is not limited for a random access signal that has not been transmitted from a transportation vehicle, such as a train, so that a decrease in throughput may be limited.

### Exclusion from Limitation for Period

Also, the base station device 110 may include a storage unit configured to store information indicating a predetermined period of time. The predetermined period of time is, for example, a period of time during which a transportation vehicle, such as a train, passes the cell of the base station device 110.

The period during which a transportation vehicle, such as a train, passes is limited, and therefore the period during which a random access signal is transmitted from a transportation vehicle, such as a train, is also limited. Therefore, based on an actual measurement value, a time table of a transportation vehicle, and so on, information indicating a predetermined timing difference may be stored in advance.

The information indicating a predetermined period of time is not limited to information indicating the predetermined period of time itself, and may be information by which the predetermined period of time is identifiable. For example, the information indicating a predetermined period of time may be information indicating each period of time different from the predetermined period of time.

The controller 113 may be configured not to limit wireless transmission of a response signal performed by the transmitter 112 for a random access signal that has been received during a period different from the predetermined period, based on information stored by the storage unit. Thus, wireless transmission of a response signal is not limited for a random access signal that has not been transmitted from a transportation vehicle, such as a train, so that a decrease in throughput may be limited.

The controller 113 may also be configured not to limit wireless transmission of a response signal for a random access signal that has been received during a period of time different from the predetermined period of time or that has a timing difference different from the predetermined timing difference, based on each piece of information mentioned above and stored by the storage unit. Thus, wireless transmission of a response signal is not limited for a random access signal that has not been transmitted from a transportation vehicle, such as a train, so that a decrease in throughput may be limited.

### Second Embodiment

### Communication System According to Second Embodiment

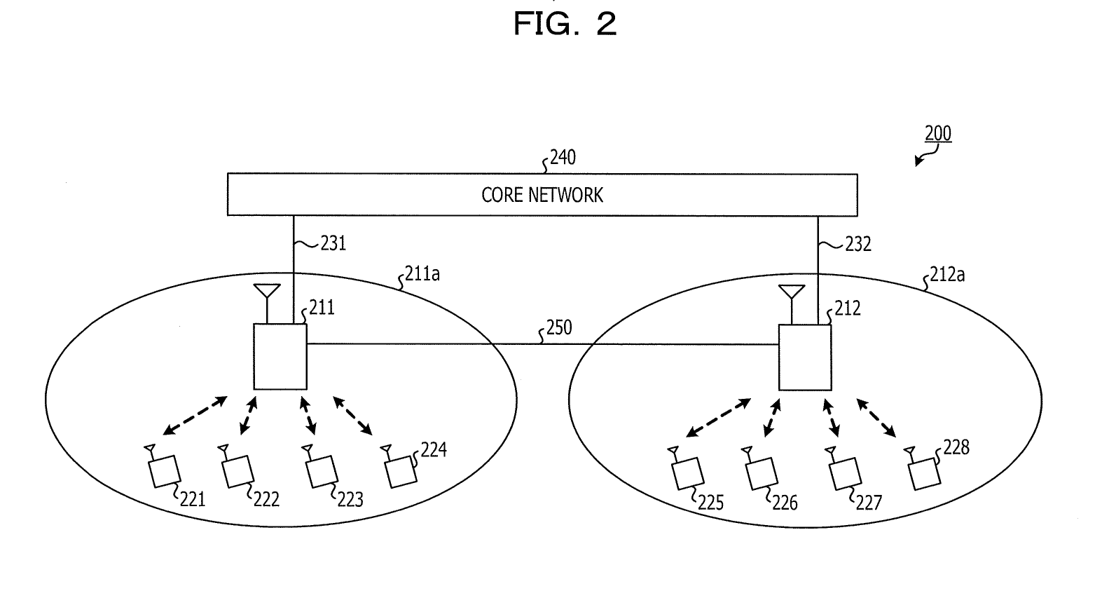

FIG. 2 is a block diagram illustrating an example of a communication system according to a second embodiment. As illustrated in FIG. 2, a communication system 200 according to the second embodiment includes base station devices 211 and 212 and mobile stations 221 to 228.

The mobile stations 221 to 224 are located in a cell 211a of the base station device 211, and perform wireless communication with the base station devices 211. The mobile stations 225 to 228 are located in a cell 212a of the base station device 212, and perform wireless communication with the base station device 212.

The base station device 211 is connected through an S1 interface 231 to a core network 240. The base station device 212 is connected through an S1 interface 232 to the core network 240. The base station device 211 and the base station device 212 are connected to each other through an X2 interface 250.

The base station device 110 illustrated in FIG. 1A and FIG. 1B is applicable to, for example, the base station devices 211 and 212. The terminal device 120 illustrated in FIG. 1A and FIG. 1B is applicable to, for example, the mobile stations 221 to 228.

### Initial Access to Wireless Base station device of Mobile Station

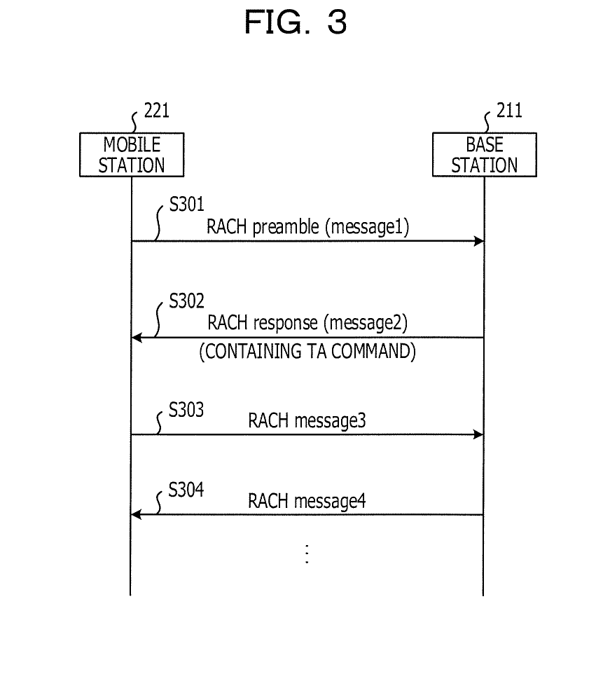

FIG. 3 is a sequence diagram illustrating an example of initial access to a wireless base station device of a mobile station. With reference to FIG. 3, by way of example, the case where the mobile station 221 initially accesses the base station device 211 will be described.

First, the mobile station 221 wirelessly transmits a random access signal (RACH preamble), as a message 1, to the base station device 211 (step S301). Thereafter, the base station device 211 and the mobile station 221 perform connection using radio resources such as a downlink physical channel and an uplink physical channel defined in LTE.

For example, the base station device 211 wirelessly transmits a RACH response, as a message 2, to the mobile station 221 (step S302). In response to this, the mobile station 221 wirelessly transmits a message 3 to the base station device 211 (step S303). In response to this, the base station device 211 wirelessly transmits a message 4 to the mobile station 221 (step S304). Through the process of these steps, the base station device 211 links the random access signal received in step S301 with the mobile station 221, and starts wireless transmission with the mobile station 221.

Examples of the downlink physical channel include a physical downlink control channel (PDCCH) and a physical downlink shared channel (PDSCH). Examples of the uplink physical channel include a physical uplink control channel (PUCCH) and a physical uplink shared channel (PUSCH).

### Base station device According to Second Embodiment

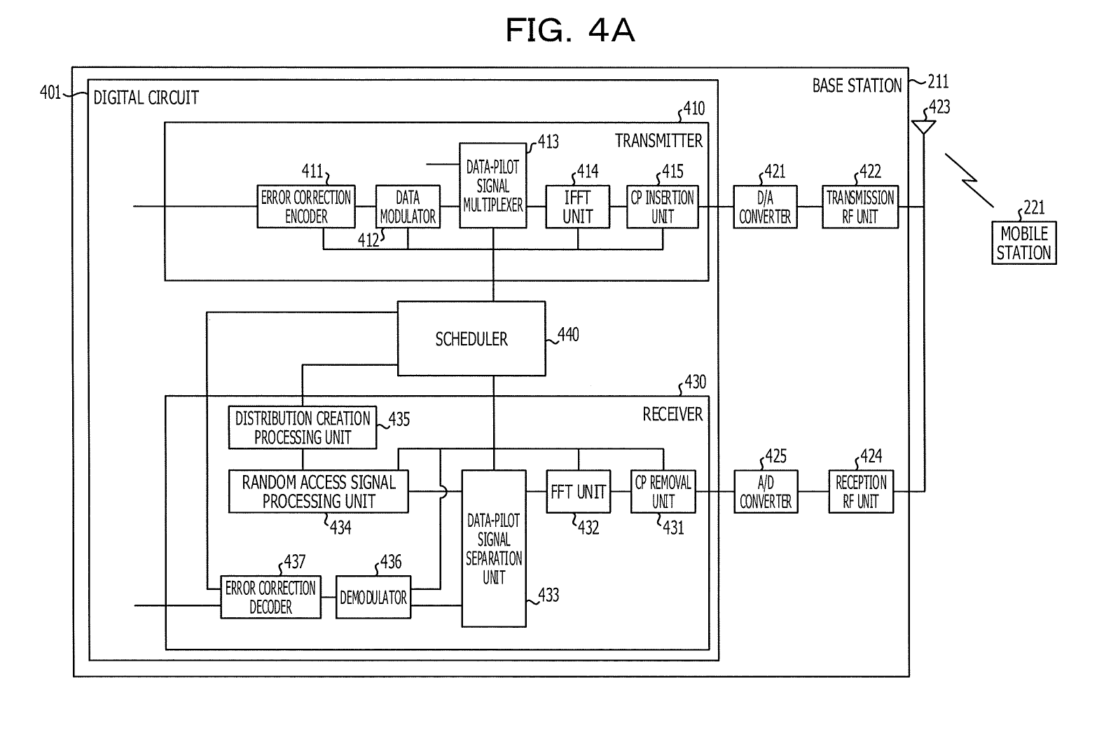

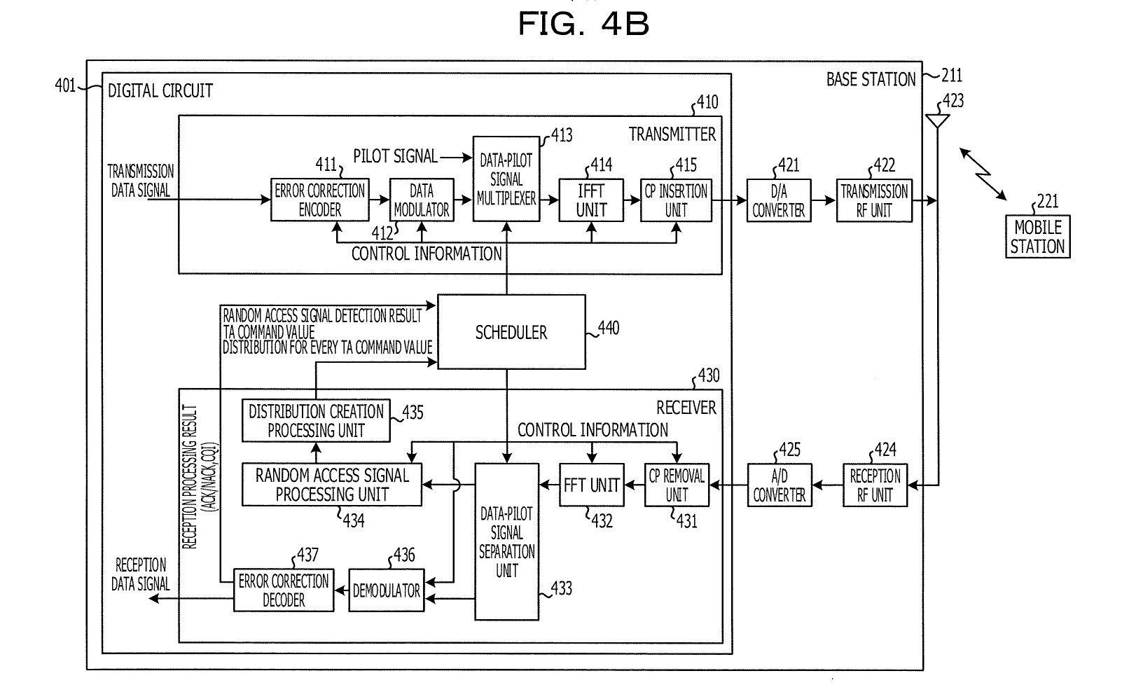

FIG. 4A is a block diagram illustrating an example of a base station device according to a second embodiment. FIG. 4B is a block diagram illustrating an example of the flow of signals in the base station device illustrated in FIG. 4A. The base station device 211 will be described here, and a similar description applies to the base station device 212. In the example illustrated in FIG. 4A and FIG. 4B, the base station device 211 is a base station device that performs wireless communication based on orthogonal frequency division multiplexing access (OFDMA).

The base station device 211 includes, as illustrated in FIG. 4A and FIG. 4B, a transmitter 410, a digital-to-analog (D/A) converter 421, a transmission radio frequency (RF) unit 422, an antenna 423, a reception RF unit 424, an analog-to-digital (A/D) converter 425, a receiver 430, and a scheduler 440.

The transmitter 410 performs modulation processing of downlink signals to be transmitted. For example, the transmitter 410 includes an error correction encoder 411, a data modulator 412, a data-pilot signal multiplexer 413, an inverse fast Fourier transform (IFFT) unit 414, and a cyclic prefix (CP) insertion unit 415. Each of the error correction encoder 411, the data modulator 412, the data-pilot signal multiplexer 413, the IFFT unit 414, and the CP insertion unit 415 operates in accordance with a control signal from the scheduler 440.

A downstream transmission data signal output from a higher-level processing unit and to be transmitted by the base station device 211 is input to the error correction encoder 411. The error correction encoder 411 performs error correction encoding on the input transmission data signal. Then, the error correction encoder 411 outputs the transmission data signal on which error correction encoding has been performed to the data modulator 412.

The data modulator 412 performs modulation using a transmission data signal output from the error correction encoder 411. Then, the data modulator 412 outputs a transmission data signal obtained by modulation to the data-pilot signal multiplexer 413.

The transmission data signal output from the data modulator 412 and a pilot signal are input to the data-pilot signal multiplexer 413. The data-pilot signal multiplexer 413 multiplexes the input transmission data signal and pilot signal. Then, the data-pilot signal multiplexer 413 outputs a transmission signal obtained by multiplexing to the IFFT unit 414.

The IFFT unit 414 performs inverse fast Fourier transform (IFFT) on the transmission signal output from the data-pilot signal multiplexer 413. Then, the IFFT unit 414 outputs the transmission signal on which IFFT has been performed to the CP insert unit 415.

The CP insertion unit 415 inserts a cyclic prefix (CP) to the transmission signal output from the IFFT unit 414. Then, the CP insertion unit 415 outputs the transmission signal to which the CP has been inserted to the D/A converter 421.

The D/A converter 421 converts the transmission signal output from the transmitter 410 into an analog signal. Then, the D/A converter 421 outputs the transmission signal converted into the analog signal to the transmission RF unit 422.

The transmission RF unit 422 performs radio frequency (RF) processing on the transmission signal output from the D/A converter 421. The RF processing performed by the transmission RF unit 422 includes, for example, conversion from a baseband frequency band to a radio frequency band. Then, the transmission RF unit 422 outputs the transmission signal on which RF processing has been performed to the antenna 423.

The antenna 423 wirelessly transmits transmission signals output from the transmission RF unit 422 to mobile stations such as the mobile station 221. The antenna 423 also receives signals wirelessly transmitted from mobile stations such as the mobile station 221. Then, the antenna 423 outputs the received signals (reception signals) to the reception RF unit 424.

The reception RF unit 424 performs RF processing on a reception signal output from the antenna 423. The RF processing performed by the reception RF unit 424 includes, for example, conversion from a radio frequency band to a baseband frequency band. Then, the reception RF unit 424 outputs the reception signal on which RF processing has been performed to the A/D converter 425.

The A/D converter 425 converts the reception signal output from the reception RF unit 424 to a digital signal. Then, the A/D converter 425 outputs the reception signal converted to the digital signal to the receiver 430.

The receiver 430 performs demodulation processing on the received uplink signal. For example, the receiver 430 includes a CP removal unit 431, a fast Fourier transform (FFT) unit 432, a data-pilot signal separation unit 433, a random access signal processing unit 434, a distribution creation processing unit 435, a demodulator 436, and an error correction decoder 437. Each of the CP removal unit 431, the FFT unit 432, the data-pilot signal separation unit 433, the random access signal processing unit 434, the distribution creation processing unit 435, the demodulator 436, and the error correction decoder 437 operates in accordance with a control signal from the scheduler 440.

The CP removal unit 431 removes a CP inserted into a reception signal output from the A/D converter 425. Then, the CP removal unit 431 outputs the reception signal from which the CP has been removed to the FFT unit 432.

The FFT unit 432 performs fast Fourier transform (FFT) of the reception signal output from the CP removal unit 431. Then, the FFT unit 432 outputs the reception signal on which FFT has been performed to the data-pilot signal separation unit 433.

The data-pilot signal separation unit 433 performs demultiplexing of the reception signal output from the FFT unit 432. Then, the data-pilot signal separation unit 433 outputs upstream reception data of RACH obtained by the demultiplexing to the random access signal processing unit 434. The data-pilot signal separation unit 433 also outputs a reception data signal of PUSCH or PUCCH obtained by the demultiplexing to the demodulator 436.

The random access signal processing unit 434 performs random access signal processing based on the upstream reception data output from the data-pilot signal separation unit 433. For example, the random access signal processing unit 434 detects random access signals from the upstream reception data and calculates TA command values (timing differences) for the detected random access signals. Then, the random access signal processing unit 434 outputs the result of detection of random access signals and TA command values calculated for the detected random access signals to the distribution creation processing unit 435.

Based on the result of detection of random access signals and the TA command values both output from the random access signal processing unit 434, the distribution creation processing unit 435 creates distribution of random access signals (mobile stations) for every TA command value. Then, the distribution creation processing unit 435 outputs the detection result and the TA command values, which have been output from the random access signal processing unit 434, and the created distribution for every created TA command value to the scheduler 440.

The demodulator 436 demodulates the reception data signals output from the data-pilot signal separation unit 433. Then, the demodulator 436 outputs the reception data signal obtained by demodulation to the error correction decoder 437.

The error correction decoder 437 performs error correction decoding on the reception data signal output from the demodulator 436. Then, the error correction decoder 437 outputs the reception data signal obtained by error correction decoding to a higher-level processing unit. The error correction decoder 437 also outputs the result of reception processing obtained by error correction decoding to the scheduler 440. Examples of the result of reception processing include a result of error detection (acknowledgement or negative acknowledgement) and a channel quality indicator (CQI).

The scheduler 440 performs scheduling for selecting a mobile station (for example, the mobile station 221) that wirelessly communicates with the base station devices 211. That is, in a system like a mobile phone, one base station device 211 handles a plurality of mobile stations. Therefore, the scheduler 440 included in the base station device 211 selects a mobile station that actually performs data communication among a plurality of mobile stations for each of the uplink and the downlink.

By way of example, the scheduler 440 determines a mobile station to which a signal is to be transmitted and determines the transmission speed using index values calculated based on line quality and transmission data rates, and thus may allocate radio resources. Then, the scheduler 440 outputs control information in accordance with a result of scheduling, thereby controlling the transmitter 410 and the receiver 430.

Also, at the timing of reception of a random access signal, for example, in order for the sequence to proceed as illustrated in FIG. 3, the scheduler 440 selects a mobile station for each of the uplink and downlink and allocates radio resources. At the time of reception of a random access signal, the result of detection of the random access signal from the random access signal processing unit 434 is input to the scheduler 440. Based on the input result of detection a random access signal, the scheduler 440 allocates radio resources to the detected random access signal, and controls the transmitter 410 so as to return a response to a mobile station.

The response to a random access signal is made, for example, using a RACH response (message 2) illustrated in FIG. 3. Then, each time a response from a mobile station is ascertained, the scheduler 440 performs the sequence of random access while using radio resources. At this time, the communication environment and the volume of data possessed by a mobile station are unknown, and therefore the scheduler 440 allocates minimum radio resources for securing the message volume in order to perform the sequence.

The scheduler 440 also stores a TA command in a RACH response (message 2) to be transmitted from the transmitter 410 in response to a random access signal, thereby causing the mobile station 221 to perform control of a transmission timing. The scheduler 440 also controls limitation of a response, to a random access signal, performed by the transmitter 410, based on a result of detection of random access signals output from the distribution creation processing unit 435, TA command values, and distribution for every TA command.

The transmitter 410, the receiver 430, and the scheduler 440 may be implemented, for example, by a digital circuit 401. A field programmable gate array (FPGA) and a digital signal processor (DSP), for example, may be used for the digital circuit 401.

The receiver 111 illustrated in FIG. 1A and FIG. 1B may be implemented, for example, by the antenna 423, the reception RF unit 424, the A/D converter 425, and the receiver 430. The transmitter 112 illustrated in FIG. 1A and FIG. 1B may be implemented, for example, by the transmitter 410, the D/A converter 421, the transmission RF unit 422, and the antenna 423. The controller 113 illustrated in FIG. 1A and FIG. 1B may be implemented, for example, by the random access signal processing unit 434, the distribution creation processing unit 435, and the scheduler 440.

### Random Access Signal Processing Unit

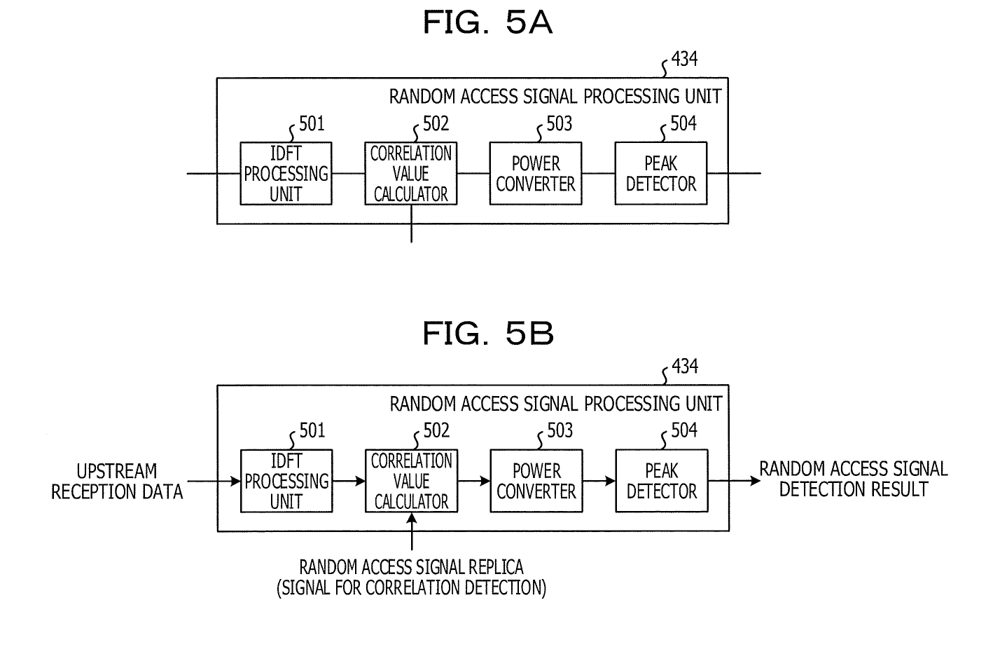

FIG. 5A is a block diagram illustrating an example of a random access signal processing unit. FIG. 5B is a block diagram illustrating an example of the flow of signals in the random access signal processing unit illustrated in FIG. 5A. In LTE-based random access signal processing, modulation processing is performed at the time of transmission in the order of a discrete Fourier transform (DFT) process, a process of mapping along the frequency axis, and IFFT. Reversely, at the time of reception, modulation processing is performed in the order of FFT, a process of demapping along the frequency axis, an inverse discrete Fourier transform (IDFT) process.

In the configuration illustrated in FIG. 4A and FIG. 4B, a demapping process is performed at a stage before the random access signal processing unit 434, and therefore the IDFT process and the subsequent processes are performed in the random access signal processing unit 434. For example, the random access signal processing unit 434 illustrated in FIG. 4A and FIG. 4B includes, for example, as illustrated in FIG. 5A and FIG. 5B, an IDFT processing unit 501, a correlation value calculator 502, a power converter 503, and a peak detector 504.

The IDFT processing unit 501 performs an IDFT process on upstream reception data output from the data-pilot signal separation unit 433 (for example, refer to FIG. 4A and FIG. 4B). The IDFT processing unit 501 outputs the upstream reception data on which the IDFT process has been performed to the correlation value calculator 502.

The upstream reception data output from the IDFT processing unit 501 and random access signal replicas (signals for correlation detection) are input to the correlation value calculator 502. The random access signal replica is a pattern that serves as a candidate random access signal, and is stored in, for example, a memory of the base station device 211.

The correlation value calculator 502 calculates a correlation value with the upstream reception data for every random access signal replica. Then, the correlation value calculator 502 outputs the calculated correlation value for every random access signal replica to the power converter 503.

The power converter 503 converts the correlation value for every random access signal replica output from the correlation value calculator 502, to a power value. Then, the power converter 503 outputs the correlation value converted to the power value to the peak detection unit 504.

The peak detector 504 performs peak detection processing for the correlation value for every random access signal replica output from the power converter 503. Then, the peak detector 504 detects a random access signal included in the upstream reception data, based on the peak detection processing. The peak detection unit 504 also calculates a timing difference relative to a predetermined reference point in time (for example, the head of a reception window) of reception of a random access signal detected in the peak detection processing. Then, the peak detector 504 outputs the result of detection of a random access signal and a TA command including the timing difference calculated for the detected random access signal to the distribution creation processing unit 435.

In this way, the random access signal processing unit 434 performs correlation calculation (autocorrelation calculation) between a reception signal and a random access signal replica, by using the correlation value calculator 502. Thus, a peak of autocorrelation appears if there is an actually transmitted random access signal, and therefore it is possible to determine the presence or absence of a random access signal, based on the peak of autocorrelation.

If there are a plurality of random access signals that may be transmitted, peaks are detected for a plurality of corresponding random access signal replicas, respectively. A matched filter, for example, may be used for the correlation calculation in the correlation value calculator 502. In the matched filter, a correlation value between a reception signal and a random access signal replica is detected, and then the detected correlation value is squared, and is converted to electric power.

### Random Access Signal Detection Processing

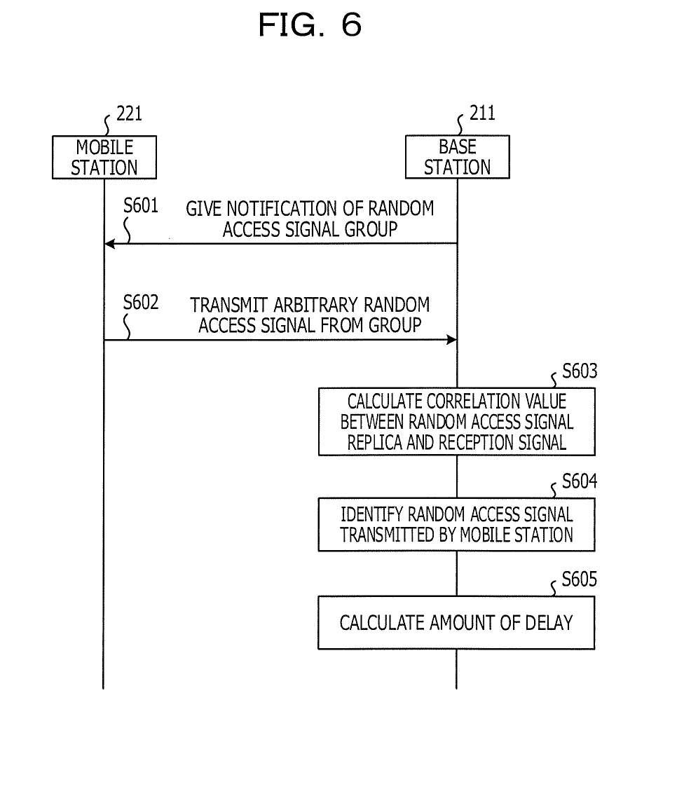

FIG. 6 is a sequence diagram illustrating an example of random access signal detection processing. The base station device 211 and the mobile station 221 perform, for example, the steps illustrated in FIG. 6. First, the base station device 211 notifies the mobile station 221 located in the cell 211a of a random access signal group (step S601). The random access signal group is a plurality of patterns that serve as candidate random access signals.

Then, the mobile station 221 selects an arbitrary random access signal from the random access signal group of which the mobile station 221 has been notified in step S601, and transmits the selected random access signal to the base station device 211 (step S602). Then, the base station device 211 calculates a correlation value between a random access signal replica corresponding to each pattern of the random access signal group of which the base station device 211 has been notified in step S601 and a reception signal (step S603).

Then, the mobile station 221 identifies the random access signal transmitted by the base station device 211, based on the magnitude of the correlation value (reception level) calculated in step S603 (step S604). The base station device 211 also calculates the amount of delay (TA command value) of the random access signal transmitted by the mobile station 221 (step S605).

In such a way, in the LTE-based random access signal processing, pattern matching is used with the correlation calculation between the random access signal group of which the mobile station 221 has been notified in advance and the reception signal.

### Delay Profile

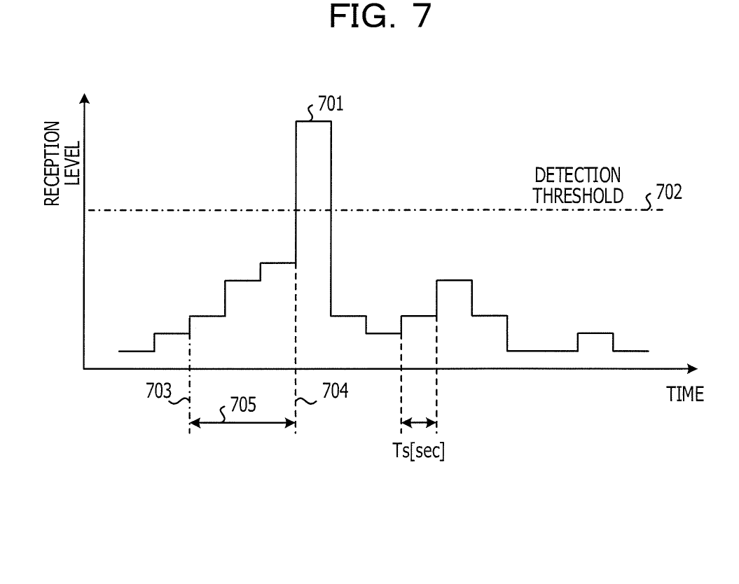

FIG. 7 is a graph illustrating an example of a delay profile. In FIG. 7, the horizontal axis represents time and the vertical axis represents the receiving level. In LTE, a Zadoff-Chu sequence, for example, is used as random access signals. The cross-correlation between a Zadoff-Chu sequence and the cyclically shifted version of itself is low.

Accordingly, only when the heads of the Zadoff-Chu sequences coincide with each other is a high correlation obtained, and as a result, the random access signal processing unit 434 may obtain, for example, a delay profile 701 as illustrated in FIG. 7.

The random access signal processing is performed in digital processing here, and therefore the delay profile 701 is a delay profile at a discretely sampled resolution. Ts [sec] denotes a period of time during which digital sampling is performed in the delay profile 701.

Using the delay profile 701 obtained by correlation detection, the random access signal processing unit 434 may determine whether the mobile station 221 has transmitted a random access signal for which the correlation detection has been performed. In addition, if the mobile station 221 has transmitted the random access signal for which the correlation detection has been performed, the random access signal processing unit 434 may measure a propagation delay period of time (TA command value) between the mobile station 221 and the base station device 211.

For example, if the peak of the reception level in the delay profile 701 exceeds a predetermined detection threshold 702, the random access signal processing unit 434 may determine that a random access signal corresponding to the delay profile 701 has been transmitted.

In addition, the random access signal processing unit 434 may calculate the propagation delay period of time from a difference between a predetermined processing reference timing 703 and the random access signal in the base station device 211. It is possible to measure a difference between the processing reference timing 703 and the random access signal, for example, by calculating a timing difference 705 between a timing at the highest reception level in the delay profile 701 and the processing reference timing 703.

The base station device 211 transmits a TA command including the calculated timing difference 705 to the mobile station 221, thereby causing a timing of transmission of a wireless signal to be adjusted in the mobile station 221.

### First Example of Limitation of Response Processing Based on Detection Result

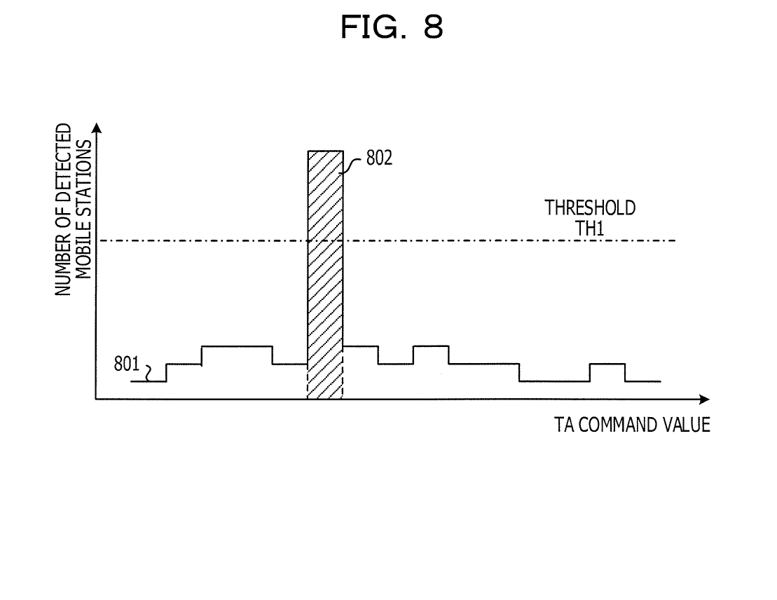

FIG. 8 is a graph illustrating a first example of limitation of response processing based on a result of detection. In FIG. 8, the horizontal axis represents the TA command value, and the vertical axis represents the number of mobile stations corresponding to random access signals detected by the random access signal processing unit 434. The distribution creation processing unit 435 creates a distribution 801 based on a result of detection of random access signals output from the demodulator 436 and TA command values.

The distribution 801 represents the number of mobile stations for every TA command value. If mobile stations located close together transmit respective random access signals to the base station device 211 at the same timing, the number of mobile stations having a specific TA command value is large as illustrated in FIG. 8.

In the first example, based on the distribution 801, the scheduler 440 does not return a RACH response to a random access signal to each of mobile stations (a shaded area 802) of a TA command value at which the number of mobile stations exceeds a threshold TH1.

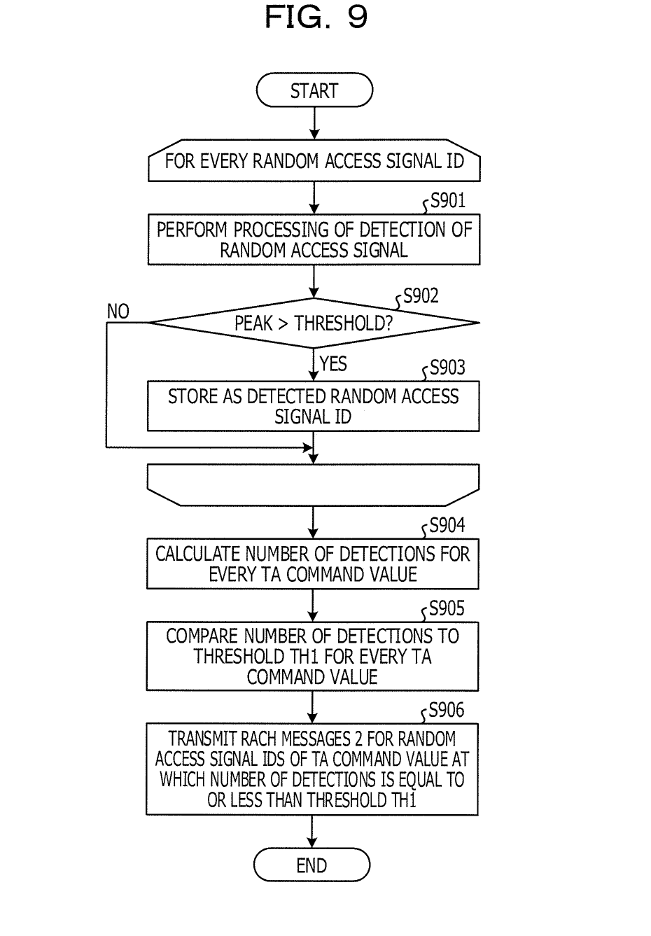

FIG. 9 is a flowchart illustrating an example of processing performed by the base station device according to the first example. In the first example illustrated in FIG. 8, the base station device 211 performs, for example, the process of steps illustrated in FIG. 9. First, the base station device 211 performs the process of the following steps S901 to S903 for every random access signal ID. The random access signal ID is identification information for a random access signal replica.

The base station device 211 first performs detection processing in the random access signal processing unit 434 using a random access signal replica identified by a random access signal ID in question (step S901). The base station device 211 then determines whether the peak of a delay profile obtained by the detection processing in step S901 exceeds a threshold (for example, the detection threshold 702) (step S902). If the peak does not exceed the threshold (step S902: No), the base station device 211 completes the process for the random access signal ID in question.

If, in step S902, the peak exceeds the threshold (step S902: Yes), the base station device 211 stores the random access signal ID in question as a detected random access signal ID (step S903). At this point, the base station device 211 also stores a TA command value in association with the detected random access signal ID. Then, the base station device 211 completes the process for the random access signal ID in question.

Having performed the process of steps S901 to S903 for every random access signal ID, the base station device 211 calculates the number of detections of random access signal IDs for every TA command value (step S904). Then, based on the result of calculation in step S904, the base station device 211 compares the number of detections to the threshold TH1 for every TA command value (step S905).

Then, based on the results of comparison in step S905, the base station device 211 transmits RACH messages 2 for random access signal IDs of each TA command value at which the number of detections is equal to or less than the threshold TH1 (step S906). Also, based on the results of comparison in step S905, the base station device 211 does not transmit RACH messages 2 for random access signal IDs of each TA command value at which the number of detections exceeds the threshold TH1. Then, the base station device 211 completes the sequential process, and proceeds to the next random access signal processing.

In this way, in the first example, for random access signals detected by performing random access signal detection processing once, the base station device 211 calculates the number of detections of random access signals (mobile stations) for every TA command value. Then, if the base station device 211 detects random access signals for the same TA command the number of which exceeds the threshold TH1, at a time, the base station device 211 does not return RACH responses to random access signals from which that TA command value is calculated. Otherwise, the base station device 211 returns RACH responses to random access signals from which a TA command value at which the number of random access signals does not exceed the threshold TH1 is calculated.

Note that the process of steps S901 to S903 for every random access signal ID may be performed, for example, in the case where a plurality of configurations of the random access signal processing unit 434 illustrated in FIG. 6 are provided. Alternatively, the process of steps S901 to S903 for every random access signal ID may be performed in the case where a single configuration of the random access signal processing unit 434 illustrated in FIG. 6 is provided and the process is performed serially.

In LTE, there is an approach in which, by making use of the feature of cross-correlation between a Zadoff-Chu sequence and the cyclically shifted version of itself, the cyclically shifted sequence in a certain cycle is handled as another random access signal. Cross-correlation between the sequences with different amounts of cyclic shift is low and therefore these sequences may be handled as different random access signals. This may reduce the number of sequences within a group, thereby reducing the amount of processing of correlation calculation.

### Result Obtained from First Example

An example of results obtained by performing the process of steps illustrated in FIG. 9 will be described next.

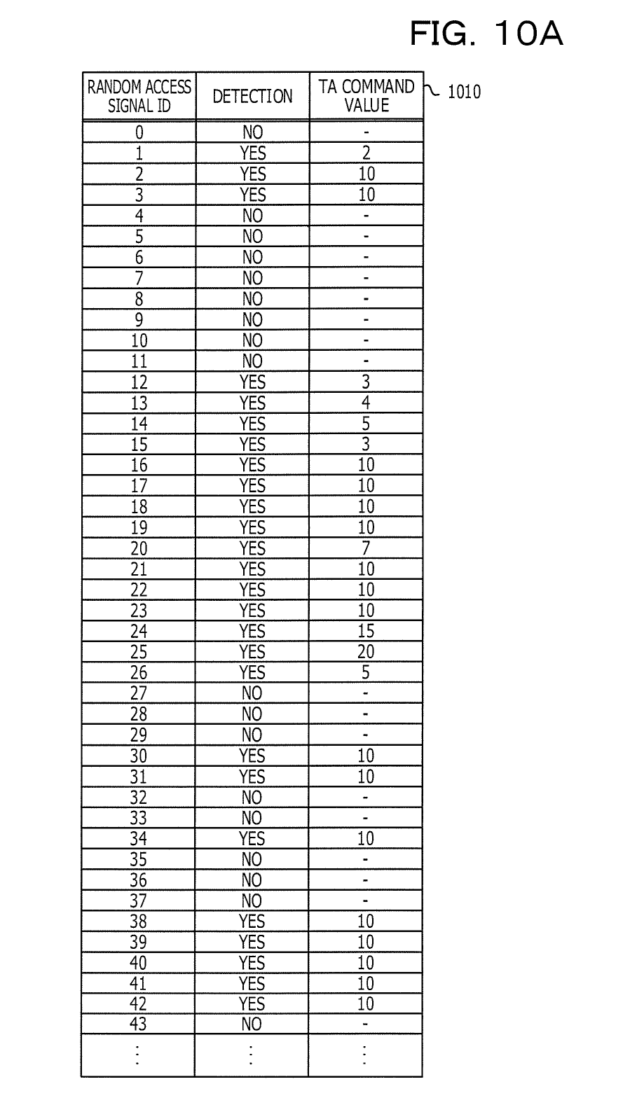

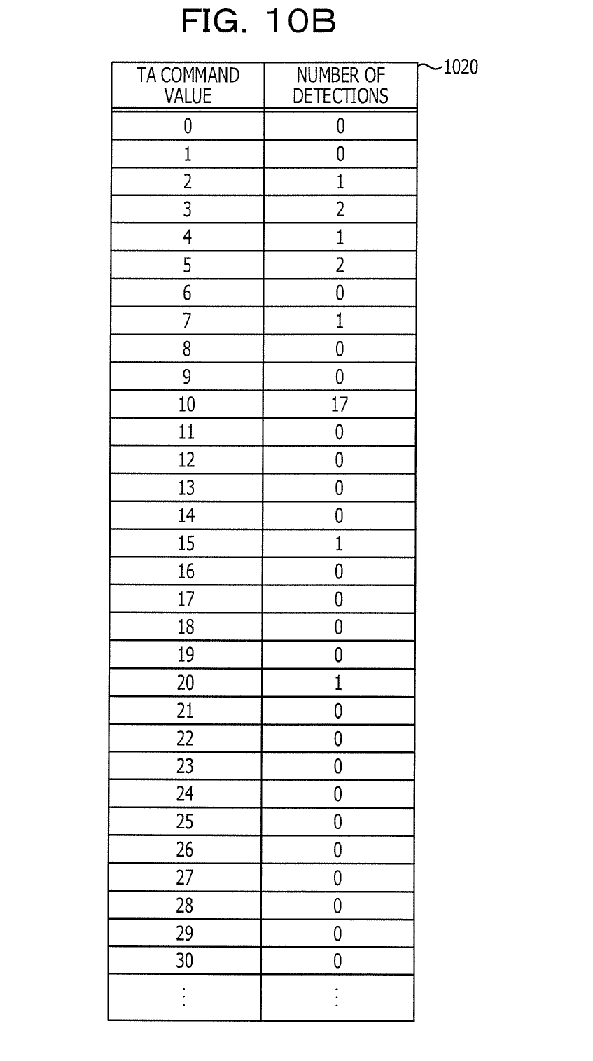

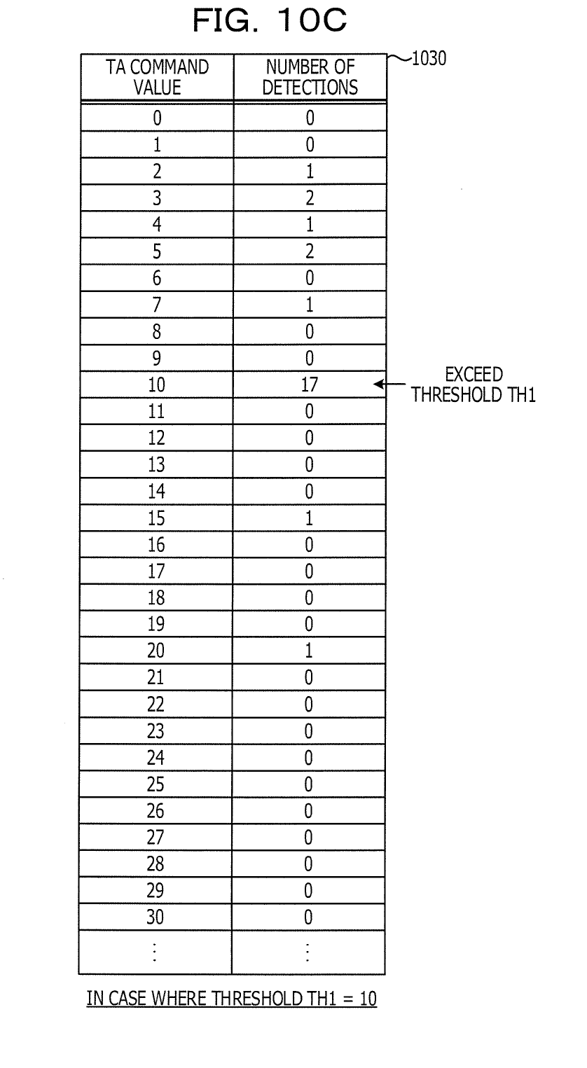

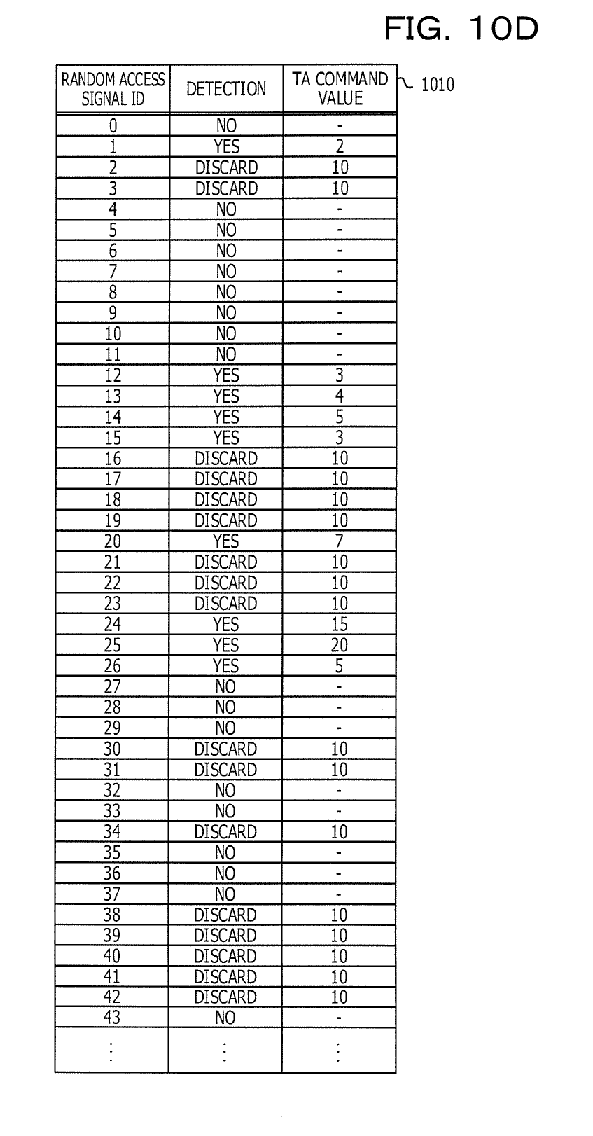

FIG. 10A is a table illustrating an example of results of detection for every random access signal ID. Detection results 1010 illustrated in FIG. 10A, for example, may be obtained by performing the process of steps S901 to S903 for every random access signal ID illustrated in FIG. 9. In the detection results 1010, “Detection” and “TA command value” are associated with every “Random access signal ID”. “Detection” indicates whether a random access signal corresponding to “Random access signal ID” is present (“Yes”) or absent (“No”). “TA command value” indicates the value of a TA command (timing difference) for the detected random access signal.

FIG. 10B is a table illustrating an example of the number of detections for every TA command value. By performing the process of step S904 illustrated in FIG. 9, distribution information 1020 illustrated in FIG. 10B, for example, may be obtained. In the distribution information 1020, “Number of detections” is associated with every “TA command value”. The “Number of detections” indicates the number of detections for the “TA command value” in the detection results 1010.

FIG. 10C is a table illustrating an example of a result of comparison between the number of detections for every TA command value and a threshold. By performing the process of step S905 illustrated in FIG. 9, a comparison result 1030 illustrated in FIG. 10C, for example, may be obtained. In the case where the threshold TH1=10, as illustrated in the comparison result 1030, only the “Number of detections” corresponding to the “TA command value”=10 exceeds the threshold TH1.

FIG. 10D is a table illustrating an example of a result of discarding of random access signals for every TA command value. By performing the process of step S906 illustrated in FIG. 9, the result of discarding of random access signals is, for example, as illustrated in FIG. 10C. In FIG. 10D, the discard result is indicated in the “Detection” field for the detection results 1010. “Discard” listed under “Detection” indicates that a random access signal of the corresponding “Random access signal ID” has been discarded, and a RACH message 2 has not been returned.

As illustrated in FIG. 10D, the base station device 211 discards random access signals having random access signal IDs and a TA command value of 10 at which the “Number of detections” exceeds the threshold TH1, among random access signal IDs of detected random access signals.

### Second Example of Limitation of Response Processing Based on Detection Result

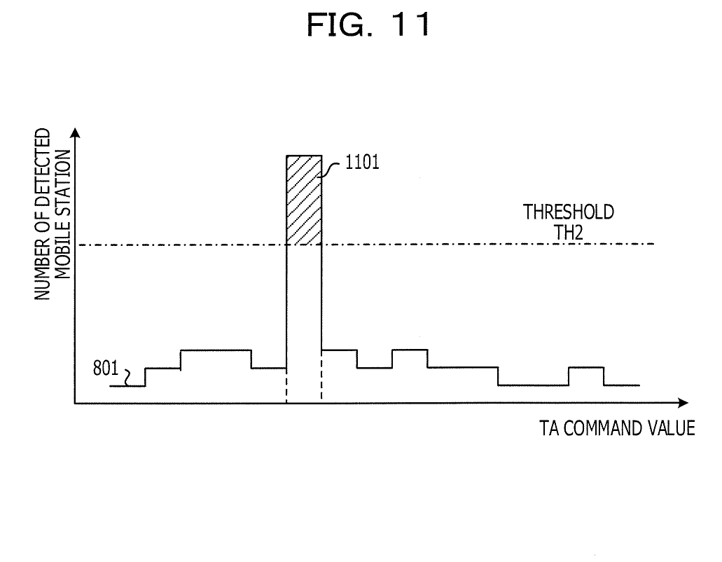

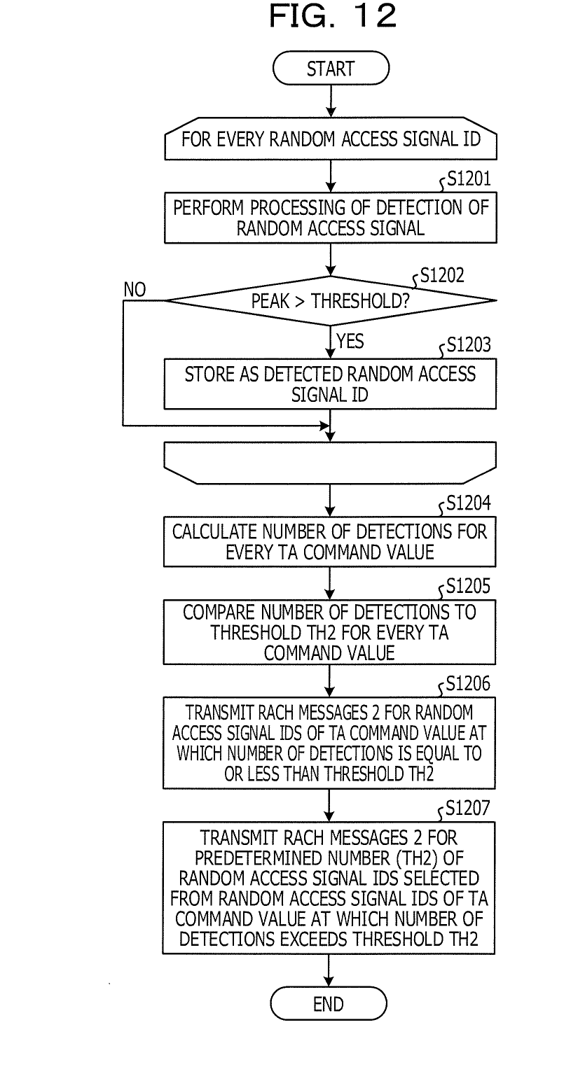

FIG. 11 is a graph illustrating a second example of limitation of response processing based on a result of detection. In FIG. 11, portions similar to those illustrated in FIG. 8 are denoted by the same reference numerals and redundant description thereof is omitted. In the second example, the scheduler 440 does not return a RACH response to a random access signal to each of mobile stations (a shaded area 1101), which are mobile stations above the threshold TH2 among mobile stations of a TA command value at which the number of mobile stations exceeds a threshold TH2 (for example, TH1>TH2), based on the distribution 801.

FIG. 12 is a flowchart illustrating an example of processing performed by the base station device according to the second example. In the second example illustrated in FIG. 11, the base station device 211 performs, for example, the process of steps illustrated in FIG. 12. The process of steps S1201 to S1204 illustrated in FIG. 12 is similar to that of steps S901 to S904 illustrated in FIG. 9. Subsequent to step S1204, based on the result of calculation in step S1204, the base station device 211 compares the number of detections to the threshold TH2 for every TA command value (step S1205).

Then, based on the result of comparison in step S1205, the base station device 211 transmits RACH messages 2 for random access signal IDs of each TA command value at which the number of detections is equal to or less than the threshold TH2 (step S1206). The base station device 211 also transmits RACH messages 2 for a predetermined number (TH2) of random access signal IDs selected from random access signal IDs of a TA command value at which the number of detections exceeds the threshold TH2 (step S1207). The order of steps S1206 and S1207 may be re-arranged.

In this way, in the second example, as in the first example, for random access signals detected by performing random access signal detection processing once, the base station device 211 calculates the number of detections of random access signals (mobile stations) for every TA command value. Then, if the base station device 211 detects random access signals the number of which exceeds the threshold TH2 for the same TA command, at a time, the number of RACH responses to the random access signals for which the TA command value is calculated is set to a number corresponding to the threshold TH2.

Which of the detected random access signals RACH responses are to be returned to may be selected based on, for example, the reception qualities of the detected random access signals. The reception levels or reception signal-to-interference ratios, for example, may be used as the reception qualities.

For example, the base station device 211 selects some of random access signals of a TA command value at which the number of detections exceeds the threshold TH2, in order of decreasing quality, such that the number of the selected random access signals corresponds to the threshold TH2, and then returns RACH responses only to the selected random access signals. Note that the number of RACH responses to be returned may be less than the threshold TH2, or larger than the threshold TH2 (provided that the number is less than the number of detections of random access signals).

### Result Obtained from Second Example

An example of results obtained by performing the process of steps illustrated in FIG. 12 will be described next.

The detection results for every random access signal ID in the second example are similar to, for example, the detection results 1010 illustrated in FIG. 10A. Also, the number of detections for every TA command value in the second example is similar to, for example, the distribution information 1020 illustrated in FIG. 10B.

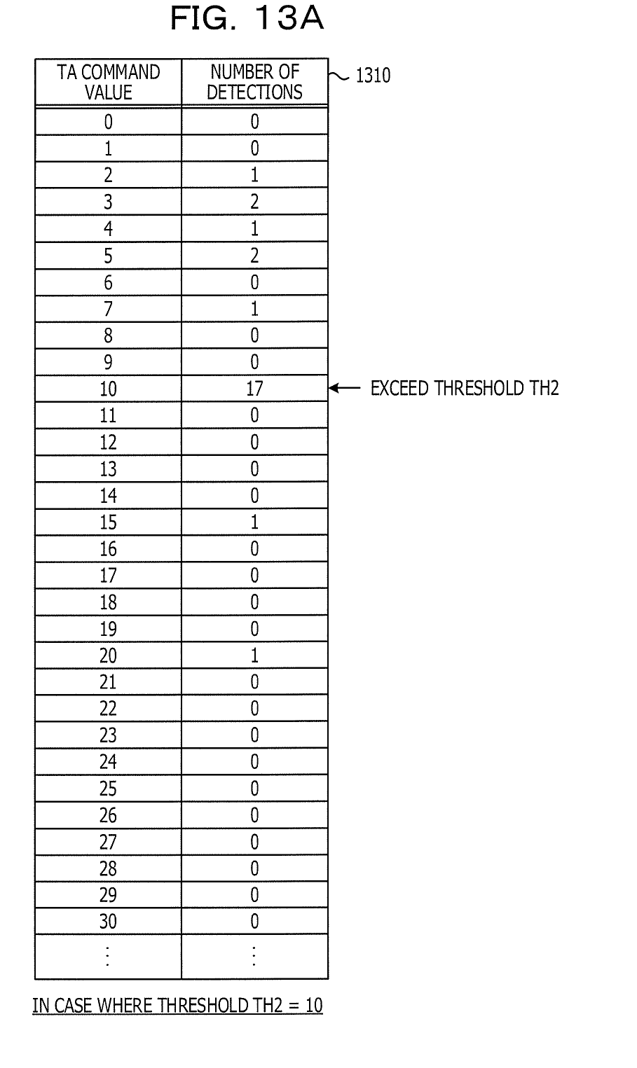

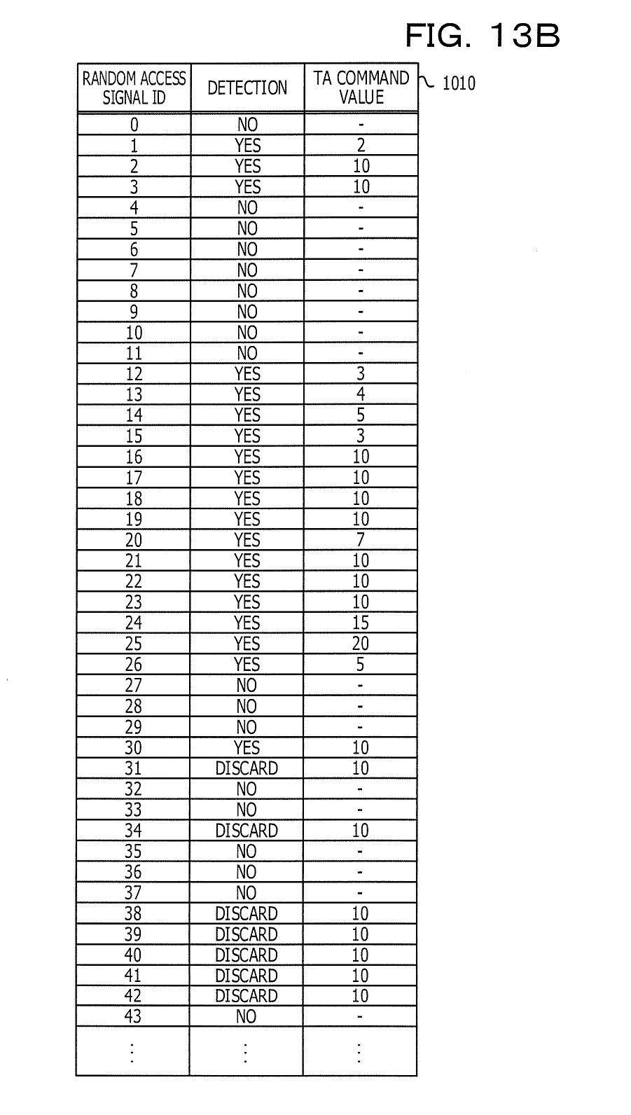

FIG. 13A is a table illustrating an example of a comparison result between the number of detections for every TA command value and a threshold. In the second example, by performing the process of step S1205 illustrated in FIG. 12, a comparison result 1310 illustrated in FIG. 13A, for example, may be obtained. In the case where the threshold TH2=10, as illustrated in the comparison result 1310, only the “Number of detections” corresponding to “TA command value”=10 exceeds the threshold TH2.

FIG. 13B is a table illustrating an example of a result of discarding of random access signals for every TA command value. In the second example, by performing the process of step S1206 illustrated in FIG. 12, the result of discarding of random access signals is, for example, as illustrated in FIG. 13B. In FIG. 13B, the discard result is indicated in the “Detection” field for the detection results 1010. “Discard” listed under “Detection” indicates that a random access signal of the corresponding “random access signal ID” has been discarded, and a RACH message 2 has not been returned.

As illustrated in FIG. 13B, the base station device 211 discards seven random access signals, which are random access signals above the threshold TH2=10 among the random access signals having random access signal IDs and a “TA command value” of 10 at which the “Number of detections” exceeds the threshold TH2.

### Mobile Station According to Second Embodiment

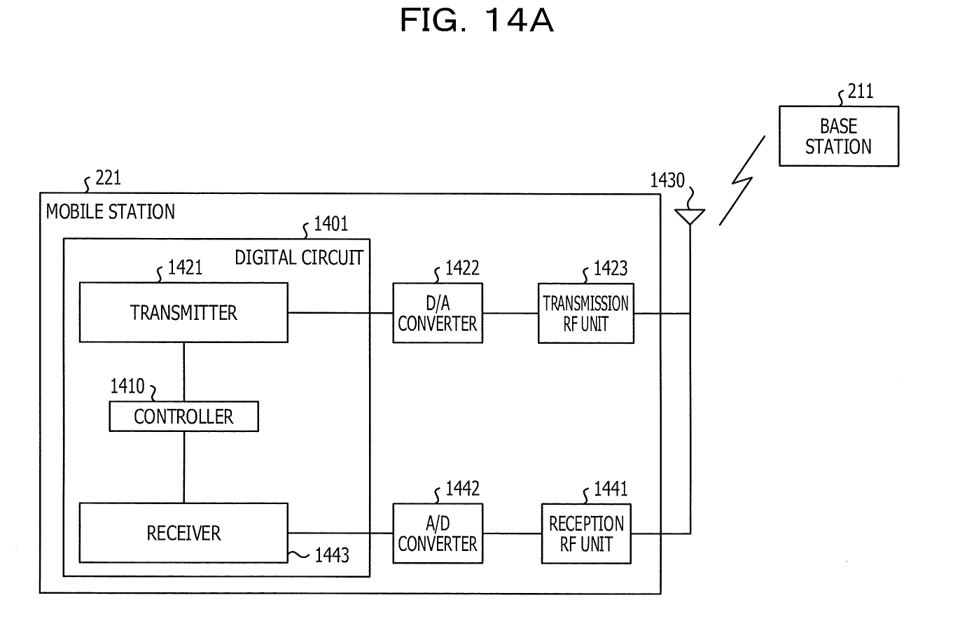

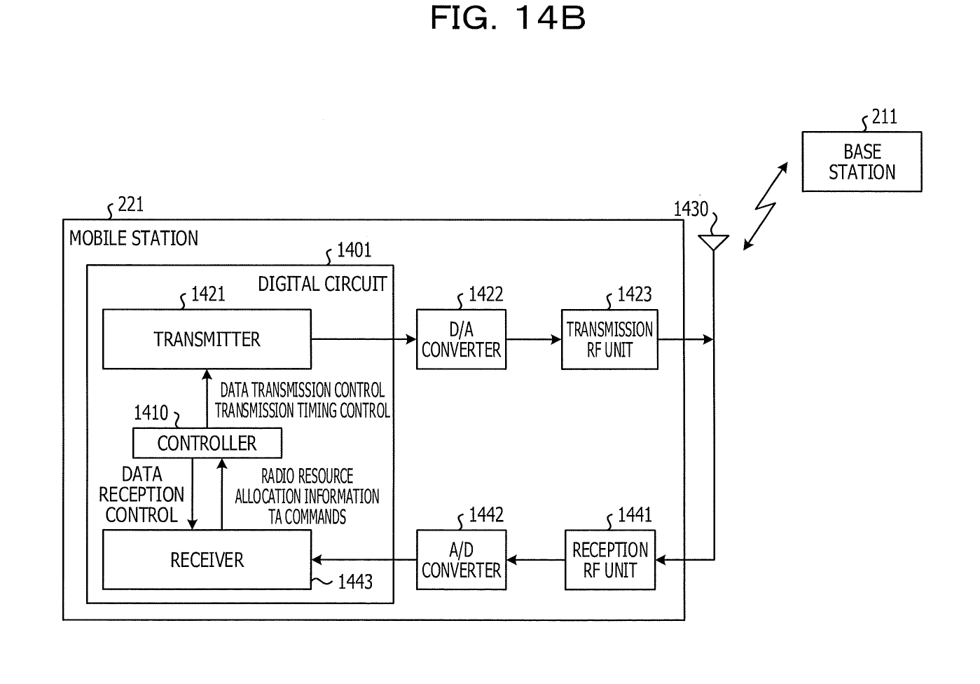

FIG. 14A is a block diagram illustrating an example of a mobile station according to the second embodiment. FIG. 14B is a block diagram illustrating an example of the flow of signals in the mobile station illustrated in FIG. 14A. The mobile station 221 will be described here, and a similar description applies to mobile stations 222 to 228.

The mobile station 221 includes, for example, as illustrated in FIG. 14A and FIG. 14B, a controller 1410, a transmitter 1421, a D/A converter 1422, a transmission RF unit 1423, an antenna 1430, a reception RF unit 1441, an A/D converter 1442, and a receiver 1443.

The controller 1410 controls data transmission of the transmitter 1421 for the uplink, based on radio resource allocation information output from the receiver 1443. The controller 1410 also controls the timing of transmission of the transmitter 1421 for the uplink, based on a TA command output from the receiver 1443. The controller 1410 also controls data reception of the receiver 1443 for the downlink, based on radio resource allocation information output from the receiver 1443.

The transmitter 1421 performs modulation processing on an uplink signal to be transmitted. Then, the transmitter 1421 outputs the transmission signal obtained through modulation processing to the D/A converter 1422. The D/A converter 1422 converts the transmission signal output from transmitter 1421 to an analog signal. Then, the D/A converter 1422 outputs the transmission signal converted to the analog signal to the transmission RF unit 1423.

The transmission RF unit 1423 performs RF processing of the transmission signal output from the D/A converter 1422. The RF processing performed by the transmission RF unit 1423 includes, for example, conversion from a baseband frequency band to a radio frequency band. Then, the transmission RF unit 1423 outputs the transmission signal on which RF processing has been performed to the antenna 1430.

The antenna 1430 wirelessly transmits transmission signals output from the transmission RF unit 1423 to the base station device 211. The antenna 1430 also receives signals wirelessly transmitted from the base station device 211. Then, the antenna 1430 outputs received signals (reception signals) to the reception RF unit 1441.

The reception RF unit 1441 performs RF processing of a reception signal output from the antenna 1430. The RF processing performed by the reception RF unit 1441 includes, for example, conversion from a radio frequency band to a baseband frequency band. Then, the reception RF unit 1441 outputs the reception signal on which RF processing has been performed to the A/D converter 1442.

The A/D converter 1442 converts the reception signal output from the reception RF unit 1441 to a digital signal. Then, the A/D converter 1442 outputs the reception signal converted to the digital signal to the receiver 1443. The receiver 1443 performs detection and demodulation processing on the reception signal output from the A/D converter 1442. The receiver 1443 also outputs radio resource allocation information and TA commands obtained through the detection and demodulation processing to the controller 1410.

The controller 1410, the transmitter 1421, and the receiver 1443 may be implemented, for example, by a digital circuit 1401. An FPGA and a DSP, for example, may be used for the digital circuit 1401.

### Application Example of Communication System According to Second Embodiment

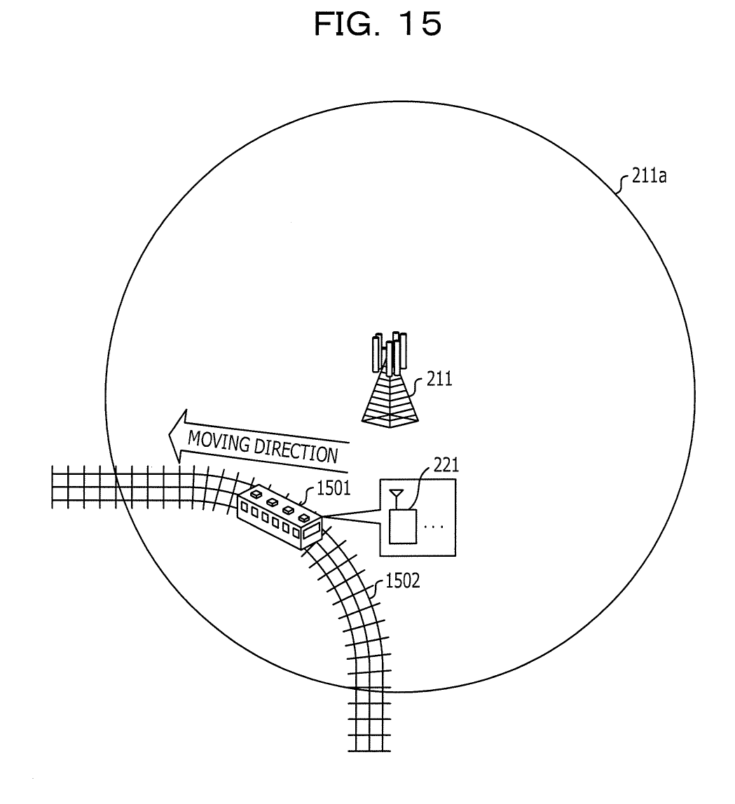

FIG. 15 is a pictorial representation illustrating an example of application of a communication system according to the second embodiment. For example, the base station device 211 according to the second embodiment is applicable to the base station device 211 illustrated in FIG. 15. A railway line 1502 through which a train 1501 passes is constructed in the cell 211a of the base station device 211. The mobile station 221 according to the second embodiment is applicable to, for example, a portable terminal device of each user who takes the train 1501.

Once the train 1501 enters the cell 211a, portable terminal devices (for example, the mobile stations 221) of users who are on the train 1501 transmit random access signals to the base station device 211. At this point, the distances between the portable terminal devices of users who are on the train 1501 and the base station device 211 are almost the same, and therefore TA command values of the random access signals received by the base station device 211 are also highly likely to be the same. For this situation, the base station device 211 limits responses to these random access signals if the number of random access signals having the same TA command value is large.

In this way, with the base station device 211, responses to random access signals from portable terminal devices of users who are on the train 1501 may be limited. This may reduce unnecessary random access processing for each mobile station that moves out of range of the cell 211a in a short period of time as the train 1501 moves, thereby improving the throughput of wireless communication with other mobile stations in the base station device 211.

While the train 1501 passes through the cell 211a, the response to a random access signal is sometimes limited for a portable terminal device the user of which is not on the train 1501 and whose distance to the base station device 211 is equal to the distance to the base station device 211 of the train 1501. However, the distance to the base station device 211 of that portable terminal device is merely temporarily equal to the distance to the base station device 211 of the train 1501, and therefore such a portable terminal device may be connected to the base station device 211 by re-transmission of a random access signal.

The base station device 211 also may store a predetermined timing difference relative to the reference point in time in the base station device 211. The predetermined timing difference is calculated in the base station device 211 for a random access signal transmitted from the location of the railway line 1502. For a random access signal having a timing difference different from the stored predetermined timing difference, the base station device 211 may be configured not to limit a response to the random access signal. Thus, the response is not limited for a random access signal that has not been transmitted from, for example, the train 1501, so that a decrease in throughput of a portable terminal device of the user who is not on the train 1501 may be limited.

The base station device 211 also may store a predetermined period of time during which the train 1501 passes the cell 211a of the base station device 211. For a random access signal received during a period of time different from (namely, out of, or not within) the stored, predetermined period of time, the base station device 211 may be configured not to limit a response to the random access signal. Thus, the response is not limited for a random access signal that has not been transmitted from the train 1501, so that a decrease in throughput of a portable terminal device of the user who is not on the train 1501 may be limited.

In this way, with the base station device 211 according to the second embodiment and so forth, responses of random access may be limited in accordance with TA commands for the received random access signals. This may reduce unnecessary random access processing, thereby improving the throughput.

For example, depending on the environment surrounding mobile stations and a radio base station device, there are some cases where random access signals are simultaneously transmitted from a plurality of mobile stations. For example, in the case where a vehicle that accommodates many mobile stations, like a crowded train, has moved into the area of a wireless base station device, many random access signals are transmitted from the mobile stations for the purposes of location registration and handover processing for the mobile stations.

If the wireless base station device tries to perform the processing in response to this by increasing the amount of processing, it is assumed that such a train as mentioned above immediately moves to another area such that the train is outside the current area. Particularly, it is assumed that such a case will become increasingly common with the recent trend toward smaller cells.

A wireless base station device tries to start random access processing (for example, refer to FIG. 2) if a random access signal is detected. Accordingly, when receiving a plurality of random access signals simultaneously, the wireless base station device tries to transmit RACH messages 2 through the downlink and receive RACH messages 3 through the uplink, using radio resources, to a plurality of mobile stations.

However, mobile stations on a moving train sometimes have moved to another area during random access processing. In this case, exchanges of random access processing made until the movement will be discarded and, as a result, unnecessary radio resources have been used. Usually, the radio resources are shared with mobile stations to which data communication services (data communication services such as Web browsing services) are provided. Therefore, unnecessary use of radio resources as mentioned above results in a reduction in allocation of radio resources to mobile stations to which data communication services are provided, which, in turn, results in a decrease in throughput of the entire system.

To address this, according to each embodiment described above, in a wireless base station device, when the number of the mobile stations with the same TA command value exceeds a threshold, those mobile stations are assumed to be moving due to being on a moving train or the like, and random access responses may be limited. This may reduce unnecessary random access processing, thereby improving throughput.

As described above, with the base station device and the communication system, improvement in throughput may be achieved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station comprising:
a receiver configured to receive a random access signal wirelessly transmitted from a terminal;
a transmitter configured to wirelessly transmit a response signal in response to the random access signal; and
a processer configured to limit a transmission of the response signal based on a timing difference between a reference timing and a reception timing when the random access signal has been received.

2. The base station according to claim 1, wherein
the response signal includes information indicating the timing difference, and
the processer is configured to limit the transmission of the response signal based on the information.

3. The base station according to claim 1, wherein
the receiver is configured to receive a plurality of random access signals wirelessly transmitted from a plurality of terminals, and
the processor is configured to
classify the plurality of random access signals into a plurality of groups based on the timing difference for each of the plurality of random access signals, and
limit a transmission of a response signal in response to each of the plurality of random access signals classified into an identified group among the plurality of groups, the identified group including random access signals that is more than a first value.

4. The base station according to claim 3, wherein the processor is configured to limit a transmission of each of the plurality of response signals in response to all of the plurality of random access signals classified into the certain group.

5. The base station according to claim 3, wherein the processor is configured to limit a transmission of each of the plurality of response signals in response to part of the plurality of random access signals classified into the certain group.

6. The base station according to claim 5, wherein
the processor is configured to select the part of the plurality of random access signals based on reception qualities of the plurality of random access signals.

7. The base station according to claim 1 further comprising:
a memory configured to store a second value,
wherein the processor is configured to limit the transmission of the response signal when the timing difference is the second value.

8. The base station according to claim 7, wherein the second value is determined based on the random access signal that has been transmitted from a given location.

9. The base station according to claim 1 further comprising:
a memory configured to store a third value,
wherein the processor is configured to limit the transmission of the response signal when the reception timing is within a period.

10. The base station according to claim 9, wherein the period is determined based on a timing when a transportation vehicle passes through a given location.

11. The base station according to claim 1, wherein limiting the transmission of the response signal includes limiting of the transmission of the response signal.

12. The base station according to claim 2, wherein the information is a timing advance (TA) command.

13. The base station according to claim 8, wherein the given location is where a transportation vehicle passes through.

14. A wireless communication system comprising:
a terminal configured to wirelessly transmit a random access signal; and
a base station configured to
receive the random access signal,
wirelessly transmit a response signal in response to the random access signal, and
limit a transmission of the response signal based on a timing difference between a reference timing and a reception timing when the random access signal has been received.

15. A wireless communication method comprising:
receiving a random access signal wirelessly transmitted from a terminal device;
wirelessly transmitting a response signal in response to the random access signal; and
limiting a transmission of the response signal based on a timing difference between a reference timing and a reception timing when the random access signal has been received.
